(19) United States
(12) Patent Application Publication
(10) Pub. No.: US 2020/0187327 A1
(43) Pub. Date: Jun. 11, 2020

(54) LIGHTING CIRCUIT AND VEHICLE LAMP

(71) Applicant: KOITO MANUFACTURING CO., LTD., Tokyo (JP)

(72) Inventor: Tomoyuki Ichikawa, Shizuoka-shi (JP)

(73) Assignee: KOITO MANUFACTURING CO., LTD., Tokyo (JP)

(21) Appl. No.: 16/710,770

(22) Filed: Dec. 11, 2019

(30) Foreign Application Priority Data
Dec. 11, 2018 (JP) 2018-231516

(51) Int. Cl. H05B 45/325; H05B 45/345; H05B 45/375; H05B 45/48; B60Q 1/14

(52) U.S. Cl. CPC H05B 45/325; H05B 45/345; H05B 45/395; H05B 45/48; B60Q 1/1415; H05B 45/375

(57) ABSTRACT

The drive circuit receives an input voltage, and to supply a drive current I_{LED} stabilized to a target amount I_{REF} to the semiconductor light source. A plurality of bypass switches is respectively connected in parallel to a corresponding part of the plurality of light-emitting elements. The bypass control unit generates phase-shifted gate pulse signals, and controls the bypass switches in correspondence to the gate pulse signals. The bypass control unit changes a duty ratio of each gate pulse signal in correspondence to a target luminance of a corresponding part, and corrects the duty ratio of each gate pulse signal based on the input voltage.

### CROSS-REFERENCE TO RELATED APPLICATIONS

This application is based upon and claims the benefit of priority from prior Japanese patent application No. 2018-231516, filed on Dec. 11, 2018, the entire contents of which are incorporated herein by reference.

### TECHNICAL FIELD

The present disclosure relates to a lamp that is to be used for an automobile and the like,

### BACKGROUND ART

As a light source to be used for a vehicle lamp, an electric bulb has been used. In recent years, however, a semiconductor light source such as an LED (light-emitting diode) is widely adopted.

FIG. 1 is a block diagram of a lamp system IR of the related art. The lamp system 1R. includes a battery 2, a switch 4, a vehicle-side ECU 6 and a vehicle lamp 10R.

The vehicle lamp 10R is supplied with a DC voltage (input voltage V_{IN}) from the battery 2 via the switch 4, thereby turning on a light source 20 by using the input voltage V_{IN} as a power supply. Also, the vehicle lamp 10R is input with a control signal from the vehicle-side ECU 6, so that it can control a luminance or light distribution pattern of the light source 20 in correspondence to the control signal.

The vehicle lamp 10R includes the light source 20 and a lighting circuit 100R. The light source 20 includes a plurality of light-emitting elements (for example, LEDs) 22_1 to 22_n (n=3 in FIG. 3) provided in series.

The lighting circuit 100 includes a constant current driver 110, and a PWM dimmer circuit 120. An output of the constant current driver 110 is connected to the light source 20, so that it supplies drive current Iₒᵤₜ stabilized to a target amount to the light source 20 to cause the light source 20 to emit light.

Since the plurality of light-emitting elements 22_1 to 22_3 is driven by the common drive current I_{OUT}, it is not possible to independently control the luminance by a so-called analog dimming method. The PWM dimmer circuit 120 is provided so as to independently control the luminances and lighting/lights-out of the plurality of light-emitting elements 22_1 to 22_3. The PWM dimmer circuit 120 includes a plurality of bypass switches SW1 to SW3 and a bypass control unit 122. When the i^{th} bypass switch SWi is off, the drive current I_{OUT} flows to the light-emitting element 22_i in parallel to the same, so that the light-emitting element 22_i emits light. When the i^{th} bypass switch SWi is on, since the drive current I_{OUT} is bypassed toward the bypass switch SWi, the light-emitting element 22_i is turned off. The bypass control unit 122 can adjust effective luminance (time average of the luminance) of the light-emitting element 22_i by turning on and off the bypass switch SWi at a high speed (for example, 60 Hz or higher), which cannot be identified with naked eyes, to adjust a duty ratio. This is referred to as PWM dimming.

### SUMMARY OF INVENTION

The inventors have recognized following problems as a result of studying the lighting circuit 100R shown in FIG. 1.

When a forward voltage is denoted as Vf₀ while the drive current I_{LED} stabilized to the target amount I_{REF} flows to the light-emitting element 22, an interterminal voltage (referred to as ‘lowest lighting voltage’) V_{MIN} of the light source 20 is Vf₀×n. In a case of n=3, V_{MIN} [symbol] 11V in a white LED, and V_{MIN} [symbol] 9V in a red LED. In other words, when the output voltage V_{OUT} of the LED driver 110 falls below the lowest lighting voltage V_{MIN}, the drive current I_{LED} cannot maintain the target amount I_{REF}, so that the luminances of the plurality of light-emitting elements 22 are all reduced and the light-emitting elements are turned off.

In a case of a lamp required to save the cost, the LED driver 110 is configured by a constant current series regulator or a voltage step-down switching converter of the constant current output. In this case, the output voltage V_{OUT} of the LED driver 110 becomes lower than the input voltage V_{IN}. While the input voltage V_{IN} is 13V in a full charged state of the battery, it may be lowered to 10V or lower as the discharge is progressed, in many cases. Therefore, when the battery voltage is lowered (referred to as ‘low voltage state’), the output voltage V_{OUT} falls below the lowest lighting voltage V_{MIN}, so that the luminances of the plurality of light-emitting elements 22 are lowered.

In order to prevent the complete lights-out of the light source 20 in the low voltage state, the bypass control unit 122 monitors the input voltage V_{IN}. When the input voltage V_{IN} becomes lower than a threshold value V_{TH}, the bypass control unit 122 determines the low voltage state, and Fixedly turns on a specific bypass switch (for example, a bypass switch on the lowest potential-side) SWn. In this state, the lowest lighting voltage V_{MIN} is Vf₀×(n−1), and a state of V_{IN}>V_{MIN} is kept. That is, in exchange for the lights-out of the light-emitting element 22_n, the lighting of the other light-emitting elements 22_1 to 22_(n−1) can be maintained.

When the above control is performed, the same light-emitting element 22_n is always turned off in the low voltage state. This is a cause of luminance unevenness when enabling the plurality of light-emitting elements 22_1 to 22_n to emit lights with the same luminance. Also, when it is intended to form a light distribution pattern by making intentionally the luminances of the light-emitting element 22_1 to 22_n different, the desired light distribution pattern is not obtained.

The present disclosure has been made in view of the above situations, and one of exemplary objects of an aspect thereof is to provide a lighting circuit by which it is possible to obtain a desired light distribution pattern or to suppress luminance unevenness even in a low voltage state.

An aspect of the present disclosure is a lighting circuit for a semiconductor light source comprising a plurality of light-emitting elements connected in series. The lighting circuit comprises a drive circuit configured to receive an input voltage and to supply a drive current to the semiconductor light source, a plurality of (m; m≥2) bypass switches each of which is connected in parallel to a corresponding part of the plurality of light-emitting elements, and a bypass control unit configured to generate phase-shifted in-phase gate pulse signals, to change a duty ratio of each gate pulse signal in correspondence to a target luminance of a corresponding part, and to control the m bypass switches in correspondence to the in-phase gate pulse signals.

Another aspect of the present disclosure is a lighting circuit for a semiconductor light source comprising a plurality of light-emitting elements connected in series. The lighting circuit comprises a drive circuit configured to receive an input voltage and to supply a drive current to the semiconductor light source, a plurality of (m; m≥2) bypass switches each of which is connected in parallel to a corresponding part of the plurality of light-emitting elements, and a bypass control unit configured to generate phase-shifted m-phase gate pulse signals, to change a duty ratio of each gate pulse signal in correspondence to a target luminance of a corresponding part, and to control the m bypass switches in correspondence to the m-phase gate pulse signals. The duty ratio of each gate pulse signal has one of a value associated with a target luminance of the corresponding part and a value associated with the input voltage.

In the meantime, it is also effective as aspects of the present disclosure to combine the above-described constitutional elements and to replace the constitutional elements and expressions of the present disclosure among a method, an apparatus, a system and the like.

According to an aspect of the present disclosure, it is possible to obtain a desired light distribution pattern or to suppress luminance unevenness even in a low voltage state.

### BRIEF DESCRIPTION OF DRAWINGS

FIG. 1 is a block diagram of a vehicle lamp in accordance with the related art.

FIG. 2 is a block diagram of a vehicle lamp having a lighting circuit in accordance with ala embodiment.

FIG. 3 is a waveform diagram for illustrating PWM dimming when an input voltage V_{IN} is high.

FIG. 4 depicts a relation between the input voltage V_{IN} in the lighting circuit and a duty ratio of a gate pulse signal Sg. FIGS. 5A to 5D are operation waveform diagrams of the lighting circuit.

FIGS. 6A to 6C illustrate correction of the duty ratio based on the PWM dimming and the input voltage V_{IN}.

FIG. 7 is waveform diagrams of a gate pulse signal Sg# having the duty ratio based on the PWM dimming and the input voltage V_{IN}.

FIG. 8 depicts a relation between the input voltage V_{IN} and an amount of light of a semiconductor light source.

FIG. 9 depicts another example of the relation between the input voltage V_{IN} in the lighting circuit and the duty ratio of the gate pulse signal Sg.

FIG. 10 is a block diagram depicting a configuration example of a bypass control unit.

FIG. 11 is an operation waveform diagram of the bypass control unit shown in FIG. 10.

FIG. 12 is a block diagram depicting a configuration example of a drive circuit.

FIGS. 13A and 13B depict a relation between the input voltage V_{IN} in a lighting circuit in accordance with a modified embodiment 1 and the duty ratio of the gate pulse signal Sg.

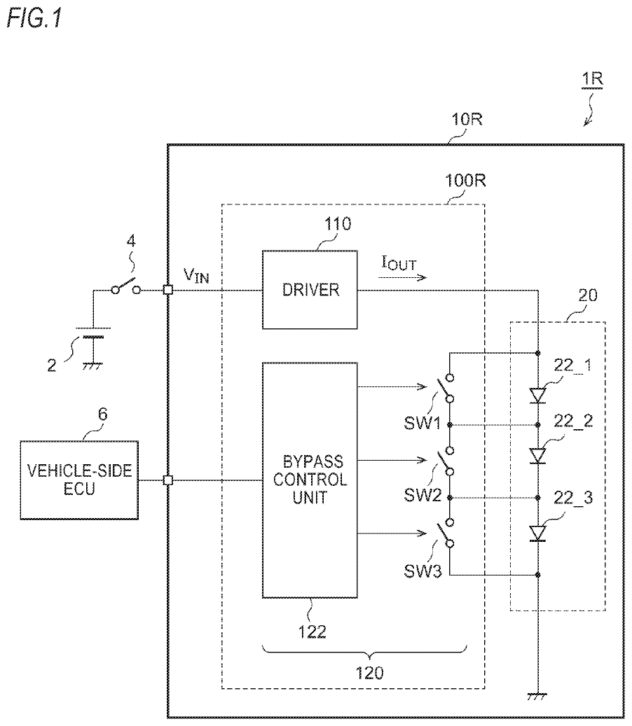

### DESCRIPTION OF EMBODIMENTS

(Outline of Embodiment)

An embodiment disclosed herein relates to a lighting circuit for a semiconductor light source including a plurality of light-emitting elements connected in series. The lighting circuit includes a drive circuit configured to receive an input voltage and to supply a drive current to the semiconductor light source, a plurality of (m; m≥2) bypass switches each of which is connected in parallel to a corresponding part of the plurality of light-emitting elements, and a bypass control unit configured to generate phase-shifted m-phase gate pulse signals, to change a duty ratio of each gate pulse signal in correspondence to a target luminance of a corresponding part, and to control the m bypass switches in correspondence to the in-phase gate pulse signals.

Thereby, it is possible to independently control the luminances of the m parts by PWM dimming. Also, a situation occurs in which the number of the light-emitting elements to be turned on at the same time is reduced by the phase shift of the gate pulse signals, as compared to a case in which the gate pulse signals have the same phase. That is, it is possible to widen a voltage range in which the plurality of light-emitting elements can be normally turned on, without sacrificing a light distribution pattern.

The bypass control unit may be configured to correct the duty ratio of each gate pulse signal, in correspondence to the input voltage. Thereby, when the input voltage is lowered, it is possible to sequentially switch the parts that are to be turned off. Thereby, when the input voltage is lowered, it is possible to prevent one of the in parts from being fixedly turned off while maintaining the PWM dimming.

The duty ratio of each gate pulse signal may be one, by which an on-time of the corresponding bypass switch is to be lengthened, of a value to be determined in correspondence to the input voltage and a value to be determined in correspondence to the target luminance. Thereby, it is possible to simplify the control.

The value of the duty ratio to be determined in correspondence to the input voltage may change continuously in correspondence to the input voltage. Thereby, as the input voltage is lowered, it is possible to continuously lower an amount of light of the semiconductor light source, and to reproduce a natural dimming power supply voltage characteristic such as a halogen law. Also, if the duty ratio is discontinuously changed, chattering that the luminance of the semiconductor light source discontinuously changes may occur at the time when the input voltage is varied in the vicinity of any threshold value. However, it is possible to suppress the chattering by changing continuously the duty ratio.

The bypass control unit may be configured to generate in-phase triangular wave signals, m first slice levels corresponding to target luminances of the in parts, and a second slice level to be determined on the basis of the input voltage, and to generate an i^{th} gate pulse signal on the basis of a comparison result of one of an i^{th} first slice level and the second slice level and an i^{th} triangular wave signal.

The drive circuit may include a voltage step-down converter, and a converter controller of a ripple control manner configured to control the voltage step-down converter in a feedback manner so that the drive current is to approach a target amount. By adopting the ripple control manner having high followability to load variation, it is possible to suppress an increase in drive current at a timing at which the bypass switch to be on is switched.

The drive circuit may further include a current smoothing filter connected to an output of the voltage step-down converter. By the current smoothing filter, it is possible to suppress variation in drive current due to the load variation.

(Embodiment)

Hereinbelow, the present disclosure will be described on the basis of a favorable embodiment with reference to the drawings. The same or equivalent constitutional elements, members and processing shown in the respective drawings are denoted with the same reference signs, and the overlapping descriptions are omitted as appropriate. Also, the embodiment is exemplary, not to limit the invention, and all features described in the embodiment and combinations thereof cannot be said as being necessarily essential to the invention.

In the specification, the state represented by the phrase “the member A is connected to the member B” includes a state in which the member A is indirectly connected to the member B via another member that does not substantially affect the electric connection state therebetween, or that does not damage the functions and effects of the connection therebetween, in addition to a state in which the members A and B are physically and directly connected to each other.

Similarly, the state represented by the phrase “the member C is provided between the member A and the member B” includes a state in which the member A and the member C or the member B and the member C are indirectly connected via another member that does not substantially affect the electric connection therebetween, or that does not damage the functions and effects of the connection therebetween, in addition to a state in Which the member A and the member C or the member B and the member C are directly connected.

In the present specification, the reference signs denoting electric signals such as a voltage signal, a current signal and the like, and circuit elements such as a resistor, capacitor and the like, also represent the corresponding voltage value, current value, resistance value, and capacitance value, as necessary.

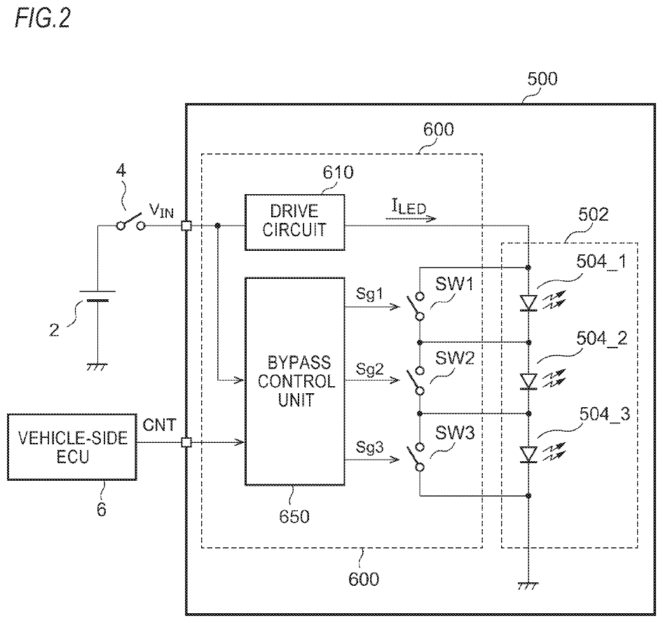

FIG. 2 is a block diagram of a vehicle lamp 500 having a lighting circuit 600 in accordance with an embodiment. To the vehicle lamp 500, a DC voltage (input voltage) V_{IN} from a battery 2 is supplied via a switch 4.

The vehicle lamp 500 includes a semiconductor light source 502 and the lighting circuit 600. The semiconductor light source 502 includes a plurality of (n, n≥2) light-emitting elements 504_1, 504_2, . . . 504_n connected in series. FIG. 2 depicts a case of n=3. The light-emitting element 504 is preferably an LED but is not limited thereto. For example, an LD (laser diode), an organic EL element and the like may also be adopted. The vehicle lamp 500 is, for example, a light distribution varying headlamp (ADB: Adaptive Driving Beam), and is configured to form a light distribution corresponding to a control command CNT from a vehicle-side ECU 6. Lights emitted from the plurality of respective light-emitting elements 504 are irradiated ahead of the vehicle by an optical system (not shown), and an illumination patter is formed by a combination thereof.

The lighting circuit 600 includes a drive circuit 610, a plurality of bypass switches SW1 to SW3, and a bypass control unit 650.

The drive circuit 610 is configured to receive an input voltage V_{IN}, and to supply a drive current I_{LED} stabilized to a target amount I_{REF} to the semiconductor light source 502. When the drive circuit 610 is configured by a boost converter, the cost increases. Therefore, the drive circuit 610 may be configured by one of (i) a constant current linear regulator, (ii) a voltage step-down switching converter of a constant current output and (iii) a combination of a voltage step-down switching converter of a constant current output and a constant current circuit. From standpoints of cost and power consumption, a voltage step-down switching converter of a constant current output is preferably used.

A plurality of m bypass switches SW1 to SWm is respectively connected in parallel to a corresponding part of the plurality of light-emitting elements 504_1 to 504_n. In the embodiment, the number n of the light-emitting elements 504 is the same as the number m of the bypass switches SW, and a part corresponding to one bypass switch SW# (#=1, 2, . . . ) is one light-emitting element 504_#. When the bypass switch SWi (i=1, 2, 3) becomes on, the drive current I_{LED} is input to the bypass switch SWi-side, and the corresponding light-emitting element 504_i is turned off.

The bypass control unit 650 is configured to independently luminances of the plurality of light-emitting elements 504_1 to 504_3 in a PWM dim (PWM light emission reduction) manner so as to obtain a light distribution corresponding to the control signal CNT. Specifically, the bypass control unit 650 is configured to acquire a dimming ratio (light emission reduction ratio) of each of the plurality of light-emitting elements 504_1 to 504_3, in correspondence to the control signal CNT The bypass control unit 650 is configured to generate m-phase gate pulse signals Sg1 to Sg3 having duty ratios d1 to d3 corresponding to the dimming ratios and having phases shifted to each other. For example, in a case of m=3, the phases of the m-phase gate pulse signals Sg1 to Sg3 may be shifted by (360/m)° (120°, in the case of m=3).

In the embodiment, when the gate pulse signal Sg# is high, the corresponding bypass switch SW# is on and the corresponding light-emitting element 504_# is turned off.

The greater the duty ratio of the gate pulse signal Sg# is, the smaller the effective luminance of the corresponding light-emitting element 504 is. Frequencies of the gate pulse signals Sg1 to Sg3 are the same, are prescribed higher than 60 Hz, and are preferably 100 to 200 Hz. Thereby, the blinking of the light-emitting element 504 cannot be recognized by human eyes.

The bypass control unit 650 is configured to monitor the input voltage V_{IN} and to correct the duty ratios d1 to d3 of the plurality of gate pulse signals Sg1 to Sg3, based on the input voltage V_{IN}. The correction is not required in a state in which the input voltage V_{IN} is sufficiently high.

The duty ratio d#′ of each gate pulse signal Sg# after the correction may be one (i.e., the greater value), by which an on-time of the corresponding bypass switch is to be lengthened, of a value d_{VIN} to be determined in correspondence to the input voltage V_{IN} and a value d# to be determined in correspondence to the target luminance. The value d_{VIN} to be determined in correspondence to the input voltage V_{IN} has a negative correlativity with the input voltage V_{IN}, so that as the input voltage V_{IN} is lowered, the value d_{VIN} increases. Thereby, it is possible to simplify the PWM dimming, and the lights-out prevention in an undervoltage state.

The configuration of the vehicle lamp 500 is as described above. Subsequently, operations thereof are described.

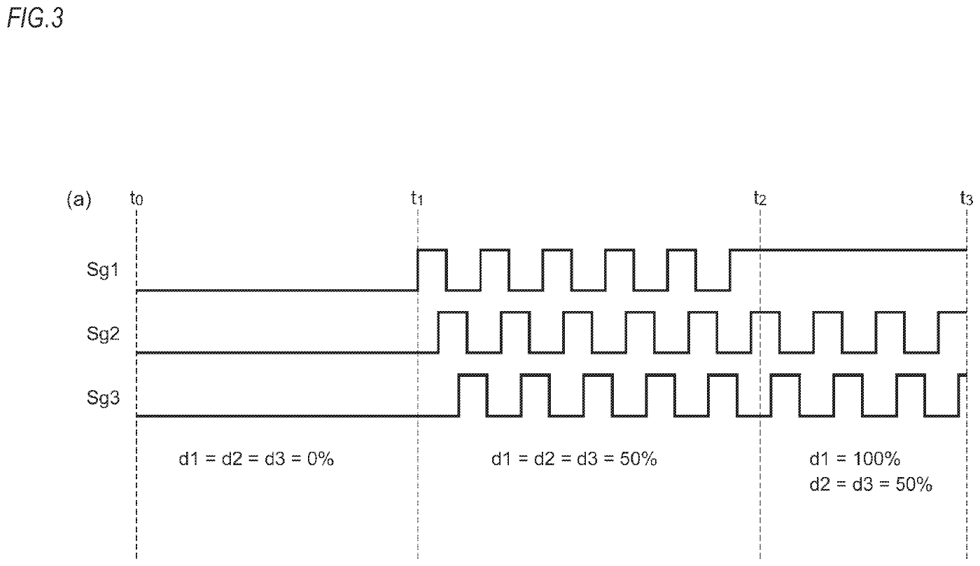

First, the PWM dimming is described. For easy understanding, a case in which the input voltage V_{IN} is sufficiently high and the duty ratio is not corrected is described. FIG. 3 is a waveform diagram for illustrating the PWM dimming that is performed when the input voltage V_{IN} is high. In FIG. 3, waveforms corresponding to different light distribution patterns are shown. For a time period from t₀ to t₁, a first light distribution pattern is formed, the duty ratios are d1=d2=d3=0%, and all the bypass switches SW1 to SW3 are fixed to off, so that all the light-emitting elements 504_1 to 504_3 emit the lights with the maximum luminance.

For a time period from t₁ to t₂, a second light distribution pattern is formed, and the three-phase gate pulse signals Sg1 to Sg3 have the duty ratio of 50%, so that the luminances of the plurality of light-emitting elements 504_1 to 504_3 are reduced to 50% of the maximum luminance.

For a time period from t₂ to t₃, a third light distribution pattern is formed, and the duty ratios are d1=100% and d2=d3=50%. Therefore, the light-emitting element 504_1 is turned off and the light-emitting elements 504_2 and 504_3 are turned on at 50% of the maximum luminance. The basic operations of the PWM dimming are as described above.

Merits of the above control are described. The merits of the control become clearer by comparison with comparative technology. In the comparative technology, the three gate pulse signals Sg1 to Sg3 have the same phase. For simplicity, a case of d1=d2=d3=50% is considered. For a first half part of a PWM period, the gate pulse signals Sg1 to Sg3 are all high, so that all the bypass switches SW1 to SW3 become on and all the light-emitting elements 504_1 to 504_3 are turned off. For a second half part of the PWM period, the gate pulse signals Sg1 to Sg3 are all low, so that all the bypass switches SW1 to SW3 become off and all the light-emitting elements 504_1 to 504_3 are turned on at the same time. That is, in the comparative technology, in order to turn on the gate pulse signals Sg1 to Sg3 at the same time, the output voltage V_{OUT} of the drive circuit 610 should be higher than Vf₀×3. In other words, in a situation of V_{OUT}<Vf₀×3, the luminances of the light-emitting elements 504_1 to 504_3 are lowered and cannot be thus normally turned on. Since a relation of V_{IN}>V_{OUT} is satisfied, when the battery voltage is lowered and V_{IN} becomes lower than Vf₀×3 (V_{IN}<Vf₀×3), the light-emitting elements cannot be normally turned on. In this case, it is necessary to reduce the number of the light-emitting elements to be turned on at the same time to two by sacrificing the desired light distribution pattern.

Considering the comparative technology, the merits of the embodiment are described. Referring to the time period from t₁ to t₂ of FIG. 3, in the case of d1=d2=d3=50%, all the three bypass switches SW1 to SW3 are not off at the same time, in other words, all the light-emitting elements 504_1 to 504_3 are not turned on at the same time. Therefore, it is sufficient that the output voltage V_{OUT} (i.e., V_{IN}) of the drive circuit 610 is higher than Vf₀×2. Therefore, as compared to the comparative technology, it is possible to widen a voltage range in which the plurality of light-emitting elements 504_1 to 504_3 can be normally turned on, without sacrificing a desired light distribution pattern.

The case of d1=d2=d3=50% is herein described but the combination of the duty ratios to realize the merits is not limited thereto. For example, in a case of d1=d2=d3>33.3%, the voltage range in which the normal lighting is possible is expanded to V_{IN}>Vf₀×2. In a case of d1=d2=d3>66.6%, the voltage range in which the normal lighting is possible is expanded to V_{IN}>Vf₀.

The vehicle lamp 500 of the embodiment further has following features.

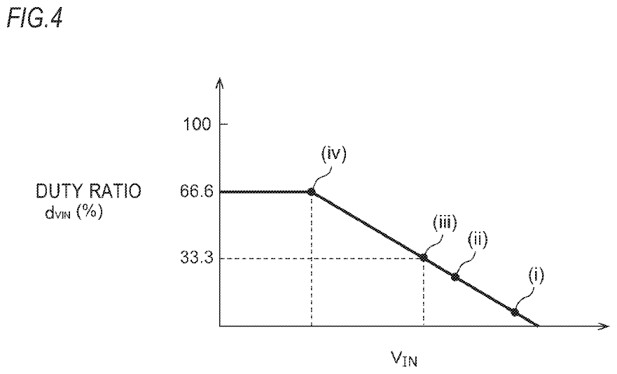

Subsequently, the correction of the duty ratio based on the input voltage V_{IN} is described. FIG. 4 depicts a relation between the input voltage V_{IN} in the lighting circuit 600 and the duty ratio d_{VIN} of the gate pulse signal based thereon. In the embodiment, the number k of the bypass switches to be on at the same time is changed to 0, 1 and 2, in correspondence to the lowering in input voltage V_{IN}, so that the number of the light-emitting elements 504 to be turned on at the same time is changed to 3, 2 and 1, in correspondence to the input voltage V_{IN}.

The duty ratio of the gate pulse signal Sg increases from 0% to (_{MAX}×100/m) % as the input voltage V_{IN} is lowered. k_{MAX} is the maximum number of the bypass switches to be on at the same time, in other words, the maximum number of the light-emitting elements 504 to be turned on at the same time. When m=3 and k_{MAX}=2, the duty ratio changes within the range from 0% to 66%.

FIGS. 5A to 5D are waveform diagrams of the lighting circuit 600. In FIG. 5, for easy understanding, the light distribution pattern is fixed to the case of d1=d2=d3=0% (the time period from t₀ to t₁ in FIG. 3). FIGS. 5A to 5D depict four states in which the input voltage V_{IN} is different. The respective states correspond to operation points (i) to (iv) in FIG. 4.

As the input voltage V_{IN} is lowered, it is possible to gradually reduce the number of the light-emitting elements 504 to be turned on. Also, since the light-emitting elements 504 that are turned off are sequentially switched with the period of the gate pulse signal Sg, it is possible to avoid a situation in which the same light-emitting element 504 is always turned off, and to solve the unevenness of the luminance distribution of the semiconductor light source 502. In a case in which the vehicle lamp 500 is a headlamp, it is possible to reduce the unevenness of the light distribution pattern.

Subsequently, operations that are performed when the duty ratio d# (#=1, 2, 3) based on the control signal CNT is not zero are described. In this case, the duty ratio of each gate pulse signal Sg# can be affected by both the control signal CNT and the input voltage V_{IN}.

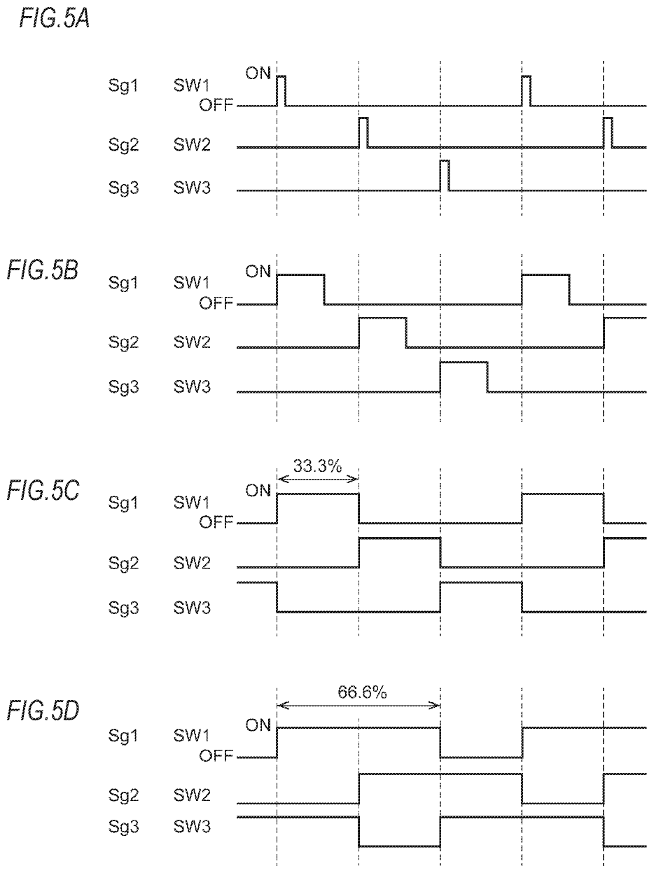

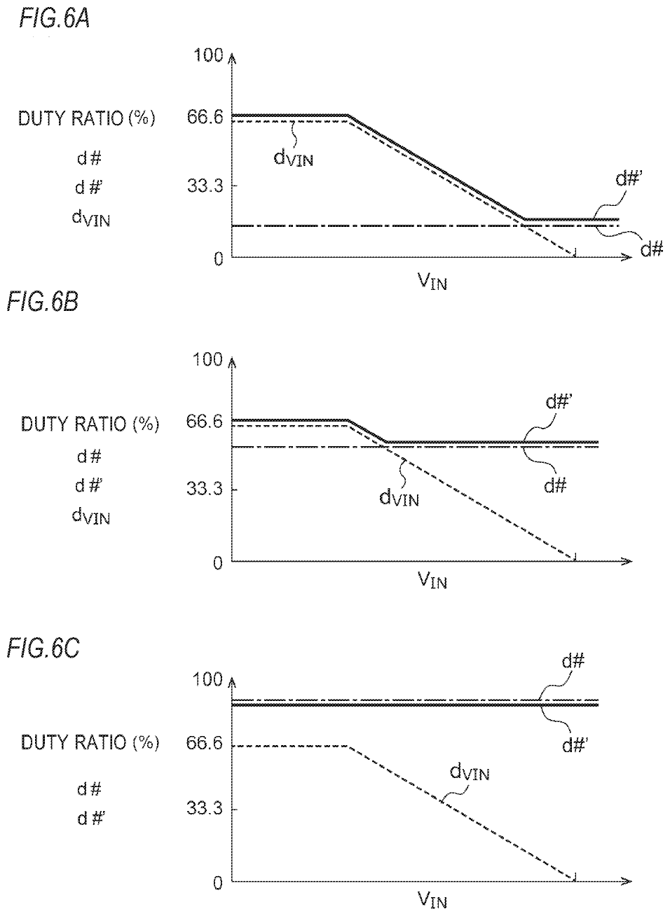

FIGS. 6A to 6C illustrate the correction of the duty ratio based on the PWM dimming and the input voltage V_{IN}. d# indicates a value based on the control signal CNT, d_{VIN} indicates a value based on the input voltage, and d#′ indicates a value after correction. In FIGS. 6A to 6C, the value d# of the duty ratio based on the control signal CNT is different. In the meantime, the value of the duty ratio is an on-duty ratio of the bypass switch, and the luminance of the light-emitting element 504_# becomes smaller as the duty ratio d#′ becomes greater.

As shown in FIGS. 6A to 6C, the duty ratio d#′ of each gate pulse signal Sg# after the correction is one (i.e., the greater value), by which an on-time of the corresponding bypass switch# is to be lengthened, of the value d_{VIN}, to be determined in correspondence to the input voltage V_{IN} and the value d# to be determined in correspondence to the target luminance. The duty ratio of the gate pulse signal Sg# is determined by this method, so that light emission reduction processing based on the PWM dimming and the input voltage can be synchronized and can be implemented with simple processing without contradiction.

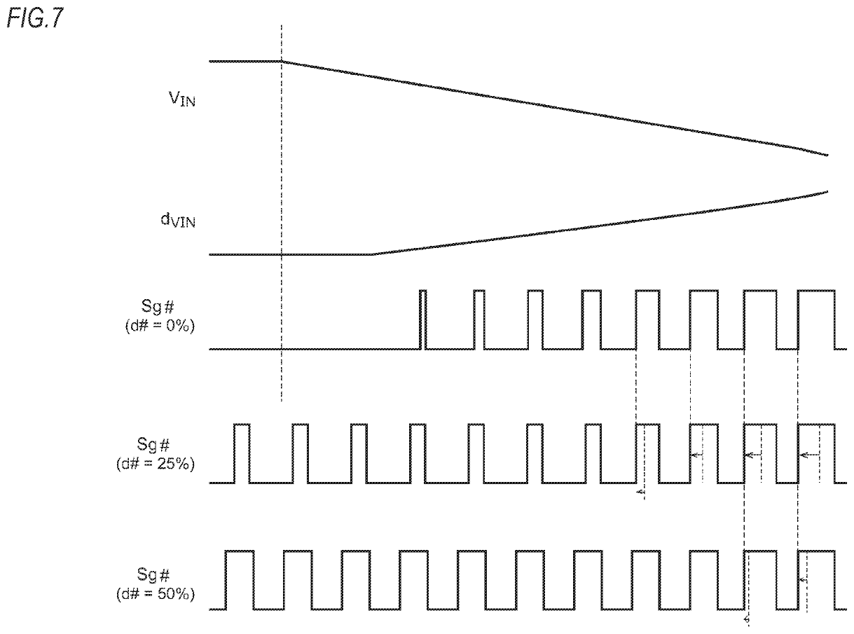

FIG. 7 is waveform diagrams of the gate pulse signal Sg# having the duty ratio based on the PWM dimming and the input voltage V_{IN}. In FIG. 7, the gate pulse signal Sg# is respectively shown when d# is 0%, 25% and 50%.

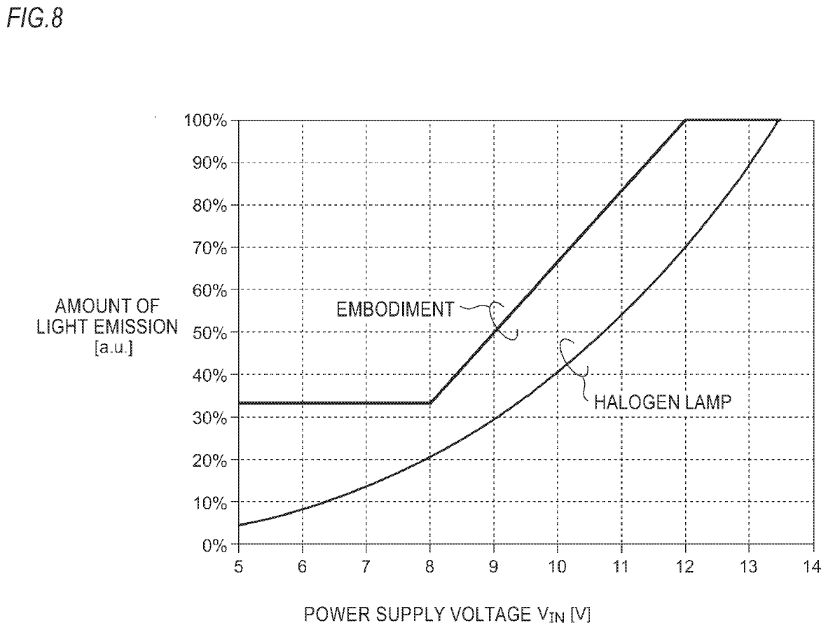

The additional merits of the vehicle lamp 500 are described. FIG. 8 depicts a relation between the input voltage V_{IN} and an amount of light emission of the semiconductor light source 502. In FIG. 8, for comparison, a characteristic of an amount of light emission of a halogen lamp of the related art with respect to a power supply voltage is also shown. The shown characteristics of the halogen lamp and the embodiment indicate relative values of the respective amounts of light emission when the power supply voltage changes, on the basis of the amount of light emission of 100% when the power supply voltage V_{IN} is 13.5V As can be seen from the comparison of the two characteristics, when the duty ratio is gradually changed in correspondence to the input voltage V_{IN}, the amount of light emission is continuously reduced as the input voltage V_{IN} is lowered, as shown in FIG. 8. Thereby, it is possible to reproduce the characteristic of the halogen lamp that the amount of light emission is reduced as the power supply voltage is lowered.

In a case in which the duty ratio is discontinuously changed with respect to the input voltage V_{IN}, chattering that the luminance of the semiconductor light source 502 discontinuously changes may occur when the input voltage V_{IN} is varied in the vicinity of a point of discontinuity. However, according to the embodiment, it is possible to suppress the chattering.

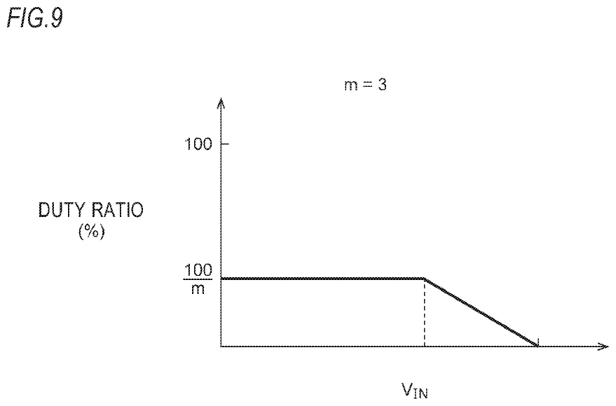

FIG. 9 depicts another example of the relation between the input voltage V_{IN} in the lighting circuit 600 and the duty ratio of the gate pulse signal Sg. In this example, k_{MAX}=1, and the number k of the bypass switches to be on at the same time is changed to 0 and 1 in correspondence to the lowering in input voltage V_{IN}, so that the number of the light-emitting elements 504 to be turned on at the same time is changed to three and two, in correspondence to the input voltage V_{IN}. The duty ratio of the gate pulse signal Sg increases from 0% to 33% (=k_{MAX}×100/m), as the input voltage YIN is lowered.

The present disclosure can be applied to various devices and methods that can be perceived from the block diagram or circuit diagram of FIG. 2 or conceived from the above description, and is not limited to the specific configuration. Hereinbelow, more specific configuration examples or embodiments are described so as to easily understand and to clarify the gist and operations of the invention, not to narrow the range of the present disclosure.

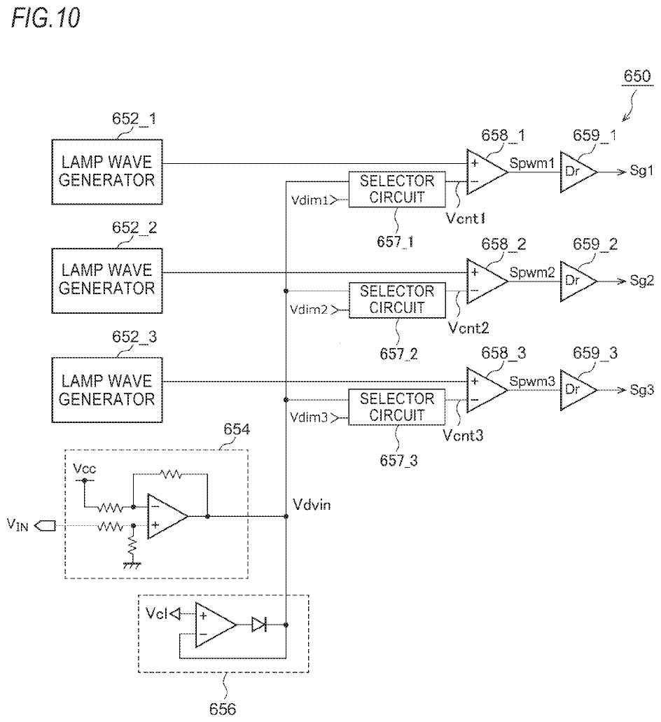

FIG. 10 is a block diagram depicting a configuration example of the bypass control unit. A plurality of (m) lamp wave generators 652_1 to 652_m is configured to generate lamp waves Vramp1 to Vramp3 of which a phase difference is 360°/m. non-inversion amplifier 654 is configured to amplify the input voltage V_{IN}. A clamp circuit 656 is configured to clamp an output voltage of the non-inversion amplifier 654 so as not to fall below a predetermined lower limit voltage Vcl. The lower limit voltage Vcl is determined so that the duty ratio is to be 66.6%. A potential Vdvin of an output node of the non-inversion amplifier 654 prescribes the value d_{VIN} based on the input voltage V_{IN}.

To a selector circuit 657_# (#=1, 2, 3), a dimming voltage Vdim#, which indicates the value d# of the duty ratio corresponding to the target luminance, and the voltage Vdvin are input. It should be noted that the higher Vdim# and Vdvin are, the smaller d# and d_{VIN} are. The selector circuit 657_# is configured. to select one (here, the lower one) of the two voltages Vdim# and Vdvin prescribing the slice levels, in accordance with a magnitude relation thereof, and to set the same to a duty ratio command voltage Vcnt#. Therefore, the selector circuit 657_#i may be configured by a minimum value circuit. A voltage comparator 658_# (#=1, 2, 3) is configured to set the duty ratio command voltage Vcnt# to the slice level, to compare the corresponding lamp wave Vramp#, and to output a rectangular pulse (PWM signal) Spwm#. Phases of the pulses are respectively shifted by 360°/m.

A driver 659_# is configured to output the gate pulse signal Sg# corresponding to the PWM signal Spwm# that is to be output from the corresponding voltage comparator 658_#.

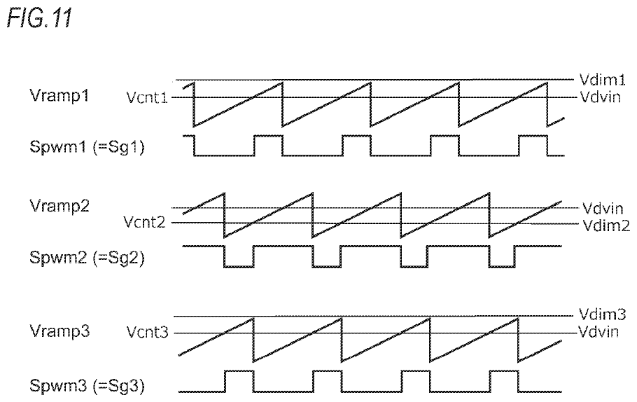

FIG. 11 is an operation waveform diagram of the bypass control unit 650 shown in FIG. 10. In the light distribution pattern, the light-emitting elements 504_1 and 504_3 are not dimmed, and only the light-emitting element 504_2 is strongly dimmed. As a result, a relation of Vdim1>Vdvin, Vdim2<Vdvin and Vdim3>Vdim3 is satisfied, According to the bypass control unit 650 of FIG. 10, it is possible to generate the plurality of gate pulse signals Sg1 to Sg3 of which the duty ratios correspond to the target luminance and the input voltage V_{IN}; and the phases are shifted.

Meanwhile, in FIG. 10, the non-inversion amplifier 654 may be replaced with an inversion amplifier. The clamp circuit 656 may be configured to limit an output voltage of the inversion amplifier so as not to exceed a predetermined upper limit level. Also, it is possible to implement the same operation by switching an inversion input and a non-inversion input of the voltage comparator 658 or configuring the driver 659 as an inversion type.

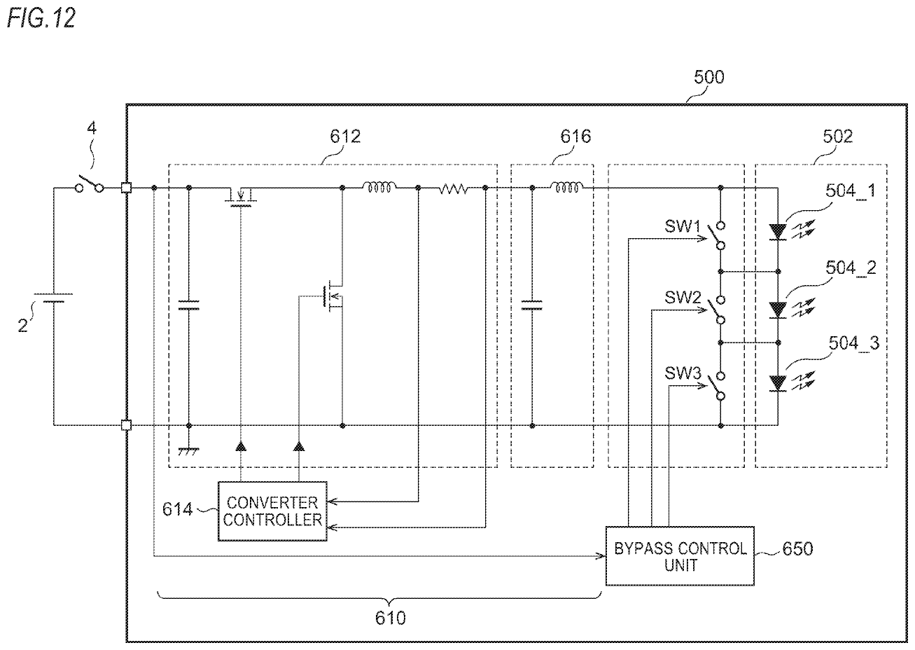

FIG. 12 is a block diagram depicting a configuration example of the drive circuit 610. The drive circuit 610 includes a voltage step-down converter (Buck converter) 612, a converter controller 614, and a current smoothing filter 616. The converter controller 614 is configured to control a switching state of the converter controller 614 by feedback so that the drive current I_{LED} is to approach the target amount I_{REF}.

In the operation modes shown in FIGS. 5A and 5B, a state in which all the bypass switches are off and a state in which only one bypass switch is on are alternately formed. When all the bypass switches are off, the voltage (i.e., the output voltage of the voltage step-down converter 612) of the interterminal voltage of the semiconductor light source 502 is 3×Vf₀, and when one bypass switch is on, the interterminal voltage of the semiconductor light source 502 is 2×Vf₀ and is discontinuously varied. Such discontinuous and steep load variation may cause an overcurrent state of the drive current I_{LED}. Therefore, in order to follow the steep load variation, the converter controller 614 of a ripple control manner having excellent high-speed responsiveness is preferably adopted. As the ripple control manner, hysteresis control (Bang-Bang control), bottom detection on-time fixed control, peak detection off-time fixed control and the like are exemplified.

When a feedback circuit using an error amplifier, not the ripple control manner, is adopted for the converter controller 614 or even when the ripple control manner is adopted, since overcurrent may be caused in the drive current I_{LED}, the current smoothing filter 616 may be connected to an output of the voltage step-down converter 612. The current smoothing filter 616 can remove ripple of the drive current I_{LED} associated with the ripple control manner, and can suppress overcurrent of the drive current I_{LED} associated with the steep load variation.

The present disclosure has been described on the basis of the embodiment. One skilled in the art can understand that the embodiment is just exemplary, that various modified embodiment can be made with respect to the respective constitutional elements and processing processes, and that the modified embodiments are also within the range of the present disclosure. Hereinbelow, the modified embodiments are described.

(Modified Embodiment 1)

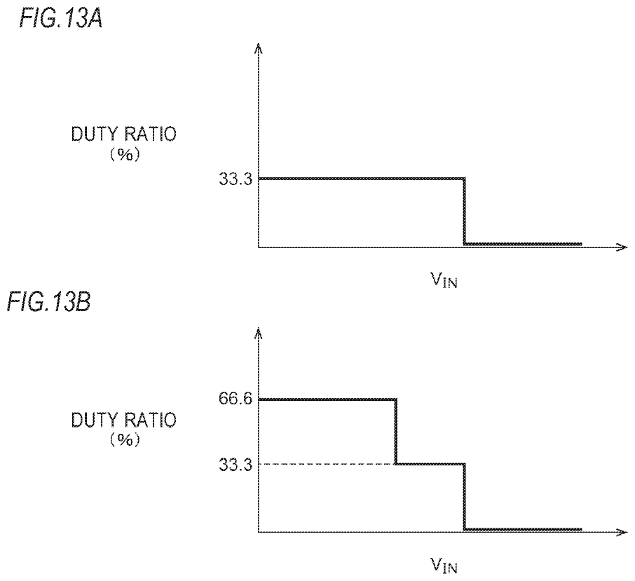

In the embodiment, the duty ratio of the gate pulse Sg is continuously changed in correspondence to the input voltage V_{IN}. However, the present disclosure is not limited thereto. FIGS. 13A and 13B depict a relation between the input voltage V_{IN} in the lighting circuit 600 in accordance with a modified embodiment 1 and the duty ratio d_{VIN} of the gate pulse signal. FIG. 13A depicts a case in which m=3 and k_{MAX}=1, and FIG. 13B depicts a case in which m=3 and k_{MAX}=2. Also in the modified embodiment 1, it is possible to prevent the specific light-emitting element 504 from being fixedly off and to suppress the luminance unevenness of the semiconductor light source 502, in the state in which the input voltage V_{IN} is lowered.

In the meantime, the function of the bypass control unit 650 in the modified embodiment 1 can be perceived as follows. That is, the bypass control unit 650 determines the number k of the bypass switches SW1 to SW3 to be on at the same time in correspondence to the input voltage V_{IN}. Then, the bypass control unit 650 switches the k bypass switches in the on-state with a predetermined period (about 100 to 200 Hz).

(Modified Embodiment 2)

In FIGS. 4 and 9, the duty ratio d_{VIN} is changed with the constant gradient with respect to the input voltage V_{IN}. However, the present disclosure is not limited thereto. For example, the duty ratio d_{VIN} may have a flat part, which does not depend on the input voltage V_{IN}, between the duty ratios 0% and 33% or between the duty ratios 33% and 66%. Alternatively, the duty ratio d_{VIN} may be changed, in accordance with a combination of a plurality of linear functions, a quadratic function or the other curve, not the line (linear function) having a constant gradient.

(Modified Embodiment 3)

In the embodiment, the phase differences of the m-phase gate pulse signals are all set to 360°)/m. However, the present disclosure is not limited thereto. For example, the phase differences are not necessarily required to be the same.

(Modified Embodiment 4)

In the embodiment, the case in which the vehicle lamp 500 is a headlamp has been described. However, the present disclosure is not limited thereto. For example, the present disclosure can also be applied to a DRL (Daytime Running Lamps) and an amber LED for turn signal.

Alternatively, the vehicle lamp 500 may be a stop lamp or a tail lamp, and may also be an LED socket in which the semiconductor light source 502 and the lighting circuit 600 are accommodated in one package. In this case, it is possible to prevent the aesthetic appearance from being deteriorated by an even luminance distribution of the semiconductor light source 502 in the low voltage state.

Although the present disclosure has been described using the specific expressions with reference to the embodiments, the embodiment just shows an aspect of the principle and application of the present disclosure. The embodiment can be diversely modified and can be changed in terms of arrangement without departing from the spirit of the present disclosure defined in the claims.

What is claimed is:

1. A lighting circuit for a semiconductor light source comprising a plurality of light-emitting elements connected in series, the lighting circuit comprising:
a drive circuit configured to receive an input voltage and to supply a drive current to the semiconductor light source;
a plurality of (m; m≥2) bypass switches each of which is connected in parallel to a corresponding part of the plurality of light-emitting elements, and
a bypass control unit configured to generate phase-shifted m-phase gate pulse signals, to change a duty ratio of each gate pulse signal in correspondence to a target luminance of a corresponding part, and to control the m bypass switches in correspondence to the m-phase gate pulse signals.

2. The lighting circuit according to claim 1, wherein the bypass control unit is configured to correct the duty ratio of each gate pulse signal, in correspondence to the input voltage.

3. A lighting circuit for a semiconductor light source comprising a plurality of light-emitting elements connected in series, the lighting circuit comprising:
a drive circuit configured to receive an input voltage and to supply a drive current to the semiconductor light source;
a plurality of (m; m≥2) bypass switches each of which is connected in parallel to a corresponding part of the plurality of light-emitting elements, and
a bypass control unit configured to generate phase-shifted in-phase gate pulse signals, to change a duty ratio of each gate pulse signal in correspondence to a target luminance of a corresponding part, and to control the in bypass switches in correspondence to the m-phase gate pulse signals,
wherein the duty ratio of each gate pulse signal has one of a value associated with a target luminance of the corresponding part and a value associated with the input voltage.

4. The lighting circuit according to claim 1, wherein the duty ratio of each gate pulse signal is one, by which an on-time of the corresponding bypass switch is to be lengthened, of a value to be determined in correspondence to the input voltage and a value to be determined in correspondence to the target luminance.

5. The lighting circuit according to claim 3, wherein the value of the duty ratio to be determined in correspondence to the input voltage changes continuously in correspondence to the input voltage.

6. The lighting circuit according to claim 2., wherein the bypass control unit is configured to generate m-phase triangular wave signals, m first slice levels corresponding to target luminances of the m parts, and a second slice level to be determined on the basis of the input voltage, and to generate an i^{th} gate pulse signal on the basis of a comparison result of one of an i^{th} first slice level and the second slice level and an i^{th}triangular wave signal.

7. The lighting circuit according to claim 1, wherein the drive circuit comprises:
a voltage step-down converter, and
a converter controller of a ripple control manner configured to control the voltage step-down converter in a feedback manner so that the drive current is to approach a target amount.

8. The lighting circuit according to claim 7, wherein the drive circuit further comprises a current smoothing filter connected to an output of the voltage step-down converter.

9. A vehicle lamp comprising:
a semiconductor light source comprising a plurality of light-emitting elements, and
the lighting circuit for driving the semiconductor light source according to claim 1.
